(19) United States
(12) Patent Application Publication
(10) Pub. No.: US 2022/0035661 A1
(43) Pub. Date: Feb. 3, 2022

(54) TASK GENERATION

(71) Applicant: FUJITSU LIMITED, Kawasaki-shi (JP)

(72) Inventors: Mehdi BAHRAMI, Santa Clara, CA (US); Wei-Peng CHEN, Fremont, CA (US); Oussama CHAFIQUI, Sunnyvale, CA (US); Nithya KUCHADI, Sunnyvale, CA (US)

(73) Assignee: FUJITSU LIMITED, Kawasaki-shi (JP)

(21) Appl. No.: 16/943,628

(22) Filed: Jul. 30, 2020

(51) Int. Cl. G06F 9/48; G06F 9/54; G06F 9/451

(52) U.S. Cl. CPC G06F 9/4881; G06F 9/451; G06F 9/542

(57) ABSTRACT

A method may include receiving a selection of an application programming interface (API) for which a task object is to be generated, and obtaining an array of parameters used in the task object, where each element in the array of parameters includes one or more of a constant value, a placeholder value, or combinations thereof, and the placeholder value includes programming to elicit user input to replace the placeholder value during execution of the task object. The method may also include combining the array of parameters with other information for the API for executing the task object into the task object, and storing the task object in a task object database.

### CROSS-REFERENCE TO RELATED APPLICATIONs

This patent application is related to U.S. application Ser. No. ______, titled TASK EXECUTION filed Jul. 30, 2020, and U.S. application Ser. No. ______, titled TASK COMBINATION filed Jul. 30, 2020, each of which are incorporated by reference in the present disclosure in their entirety.

### FIELD

Embodiments of the present disclosure relate to task generation, task execution, and/or task combination for tasks related to application programming interfaces (APIs).

### BACKGROUND

APIs are a convenient mechanism by which functionality of a separate computing system may be accessed and/or invoked. For example, such functionality may be incorporated into a software project, accessed by a database, accessed by an Internet of things (IoT) device, etc. However, such APIs are not always initially set up to perform a desired function.

### SUMMARY

One or more embodiments of the present disclosure may include a method that includes receiving a selection of an application programming interface (API) for which a task object is to be generated, and obtaining an array of parameters used in the task object, where each element in the array of parameters includes one or more of a constant value, a placeholder value, or combinations thereof, and the placeholder value includes programming to elicit user input to replace the placeholder value during execution of the task object. The method may also include combining the array of parameters with other information for the API for executing the task object into the task object, and storing the task object in a task object database.

One or more embodiments of the present disclosure may include a method that includes receiving a selection of a task object for execution, the task object related to an API, determining whether the task object includes a placeholder value in the task object, and based on the task object including a placeholder value, producing an interface via which a user submits user input related to the placeholder value as described in the task object. The method may also include replacing the placeholder value with a new value that is based on the user input received via the interface, and generating an API call to the API in a target programming language, where the API call includes the new value. The method may also include deploying the generated API call on a target platform for execution, and obtaining results of the API call.

One or more embodiments of the present disclosure may include a method that includes obtaining a set of successful responses from one or more tasks, where the one or more tasks include a specific implementation of an API call. The method may also include generating a first schema of a first response of the set of successful responses by extracting information from the first response, where the first response is responsive to a first task of the one or more tasks. The method may additionally include clustering the first schema with a second schema of a second response of the set of successful responses by applying a learning model to the first schema and the second schema, where the clustering is based at least on inputs to the first task and the first response, and creating an integrated task that includes the first task and a second task to which the second response is responsive based on the clustering of the first scheme and the second schema.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system for use with tasks related to APIs, which may include task generation, execution, and/or combination;

FIG. 2 illustrates an example of a computer-readable representation of a task;

FIG. 3 illustrates an example of a user interface for selecting a category of tasks;

FIGS. 4A and 4B illustrate examples of user interfaces used in task generation;

FIGS. 5A and 5B illustrates examples of user interfaces used in task execution;

FIGS. 6A, 6B, and 6C illustrate example visual representations of example combinations of tasks;

FIG. 7 illustrates an example flowchart of an example method of task generation;

FIG. 8 illustrates an example flowchart of an example method of task execution;

FIG. 9 illustrates an example flowchart of another example method of task execution;

FIG. 10 illustrates an example flowchart of a further example method of task execution;

FIG. 11 illustrates an example flowchart of an example method of task combination;

FIG. 12 illustrates an example flowchart of an example method of generating a schema based on a response of a successful task execution; and

FIG. 13 illustrates an example computing system.

### DETAILED DESCRIPTION

The present disclosure relates to the generation, execution, and/or combination of a task object, which may be simply referred to as a task. A task may be represented by a set of computer-readable instructions (e.g., programming code) that cause a computing system to implement a specific implementation of an API to perform a particular function to accomplish a particular objective, and may or may not involve user-input to the process. For example, a user may desire to access the twenty-five most recent unread emails from an email service that permits an API service in accessing the email accounts. Continuing the example, a task may include programming code to identify what quantity of recent unread emails to obtain, invoke the API call to access the email service, and provide the results of the API call. As another example, a user may desire to pull contacts with the last name “Smith,” and the email service may provide API calls to access an associated address book of the user. Continuing the example, a task may include programming code to verify the credentials to invoke the API call and/or access the associated email account. The task may additionally or alternatively include programming code to receive user input regarding the last name, and access the address book to acquire the contacts. By the implementation of such tasks, functionality may be built on top of existing APIs such that access to such functionality may be provided to users, whether or not they have computer programming knowledge of the operation of the specific API.

During task generation, an administrator may be permitted to identify a specific implementation of an API call to be performed to accomplish an objective of the task, such as retrieving a user-identified number of recent emails. In some embodiments, the tasks may include placeholder values for any user-input elements of the task (e.g., the number of emails or last name of the contacts, etc.). For example, during task generation, an administrator or other user may provide placeholder values that are to be replaced by the user input values. By using such an approach, each task, after being generated, may represent a set of code using which the API call may be invoked to perform the desired task, even if on an example set of data (e.g., using the placeholder values). The task may include the code to cause a user interface to be generated to obtain user input to facilitate replacing the placeholder values. Additionally or alternatively, the administrator may include a variety of other information associated with the task, such as scope, authorization type and/or credentials, any constant values, etc.

During task execution, a user may identify a task for execution. Such execution may be performed locally or in a targeted environment (e.g., in a specific programming language, in a cloud-based service, etc.). The task may execute and provide the user with an interface via which the user may provide input to facilitate replacing any placeholder values of the task with the user-input values. The response of the task execution (e.g., the result of the specific implementation of the API call) may be returned to the user. In some embodiments, the response may be stored for other use.

During task combination, a schema (e.g., hierarchical/relational data representation) of the response of a given task may be generated. For example, various elements of the response (such as key-value pairs, dictionaries, lists, etc.) may be processed to generate a computer-readable representation of the response of the executed task. In some embodiments, the tasks and/or schemas may be clustered using a machine learning model based on factors such as response, title, inputs, etc. Using the clusters of tasks, multiple tasks may be combined into a single integrated task. For example, an integrated task may utilize the response (or portions of a response) from one task as a replacement for a placeholder value of another task such that the two tasks operate in tandem to perform the overall integrated task. In some embodiments, user input may be used to replace a placeholder in the first task, and both the result of the first task and additional user input may be used to replace placeholder values in the second task.

In some circumstances, embodiments of the present disclosure may facilitate improvement in the performance of a computer by applying the teachings of the present disclosure. For example, by providing for the generation, use, and/or combination of tasks, APIs may be utilized in ways that computing devices have been unable to perform previously. For example, specific functionalities may be achieved that were previously unavailable that are added on top of existing APIs. Additionally, an improved user experience may be obtained whereby the functionalities of APIs may be deployed to achieve specific objectives via the tasks in a manner accessible to individuals without computer-programming training which may otherwise be used to access the specific objectives. For example, a particular user interface that is accessible, even without programming experience, may be provided. As an additional example, certain data, devices, and/or other resources that were previously only accessible via specific API calls may be accessed in a different and more convenient and accessible manner. For example, an end-user without computer programming training may be able to read documentation regarding an API, such as an API specification or other human-readable documents or websites regarding the API, but the end-user may not have the training required to implement the API to accomplish a desired purpose. Tasks in accordance with one or more embodiments of the present disclosure may facilitate such end-users accessing APIs to accomplish the desired purpose via tasks. As a further example, a user may observe an increased performance speed as the code and inputs for an API call may be already gathered and combined for execution.

One or more example embodiments are explained with reference to the accompanying drawings.

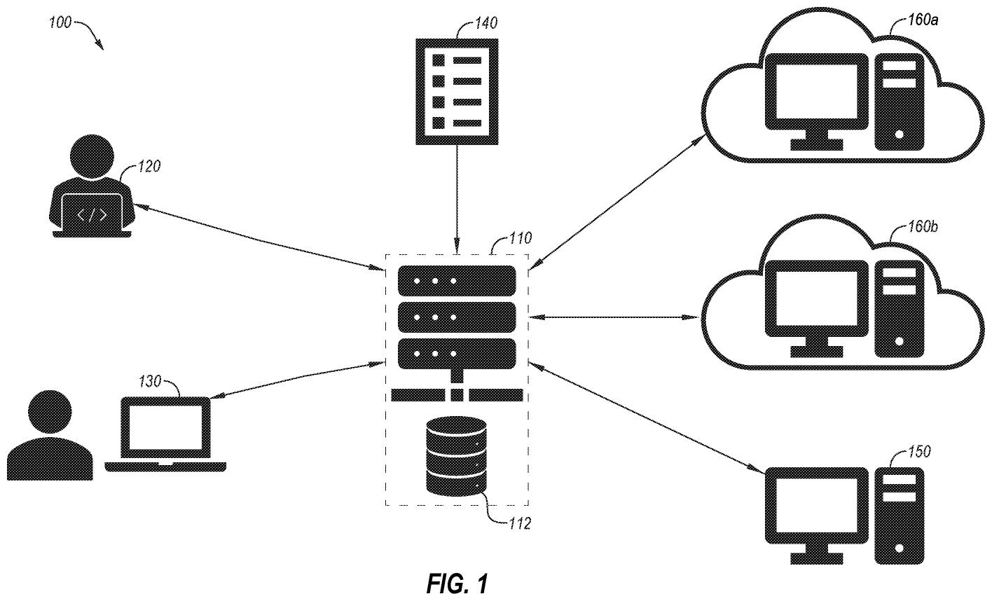

FIG. 1 is a diagram illustrating an example system 100 to facilitate task generation, task execution, and/or task combination, in accordance with one or more embodiments of the present disclosure. The system 100 may include a task system 110 used to generate, execute, and/or combine tasks. An administrator 120 may interact with the task system 110 to generate tasks and/or facilitate combinations of tasks. An end-user 130 may interact with the task system 110 to select a task for execution. One or more API specifications 140 may be accessed by the task system 110 to obtain information regarding various APIs. An API host 150 may be accessed when executing a task to invoke the functionality of an associated API. Cloud systems 160 (such as the cloud systems 160a /160b) may represent remote systems that may be invoked by the task system 110 to execute a given task.

### Task Generation

The task system 110 may obtain one or more of the API specifications 140 and may parse, analyze, or otherwise obtain information from the API specifications 140. For example, the task system 110 may access an OpenAPI Specification (OAS) for a given API and may identify endpoints via which the API may be accessed, a hypertext transfer protocol (HTTP) verb used when performing the API call, and one or more inputs used in the API, such as query input, header input, path input, and/or body input used when invoking the API. In these and other embodiments, identifiers of each of the APIs may be obtained from the API specifications 140, such as an API name, API code, a uniform resource locator (URL) or other information for identifying the API, etc. While OAS is provided as one example format of the API specification 140, it will be appreciated that any format or style may be used for the API specifications 140, such as web service definition language (WSDL).

In some embodiments, the task system 110 may utilize the information obtained from the API specification 140 to generate a template of a task. For example, aspects of the header, body, input assignment, authentication protocols, etc. of an API call may be the same each time the API call is performed, and such inputs and/or other components may be included in the task template.

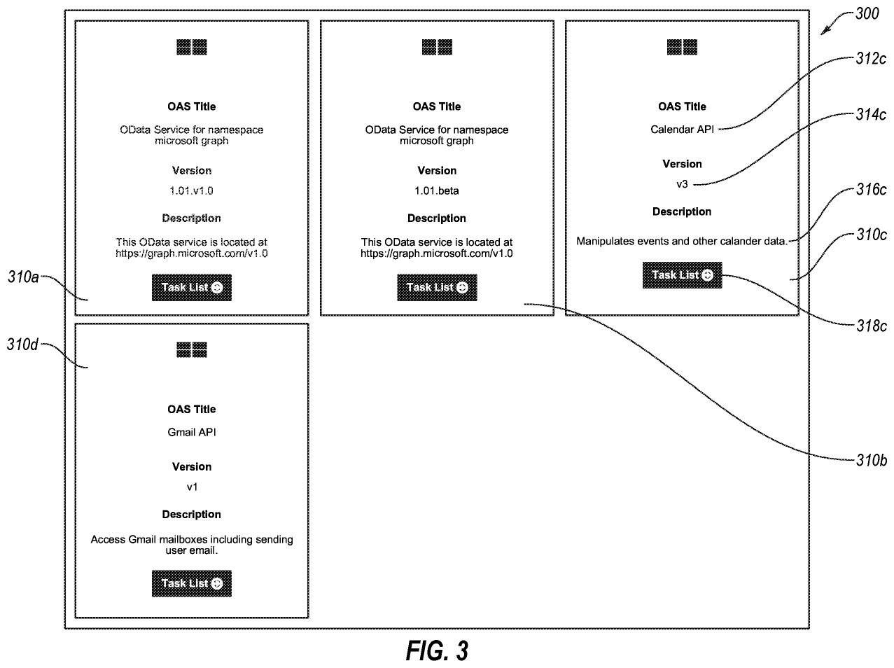

In some embodiments, one or more APIs may be presented to the administrator 120 for selection of an API to be associated with a new task being generated. An example of an interface illustrating such presentation is illustrated in FIG. 3. In some embodiments, the administrator 120 may select a template (or a preexisting task as a template), may select an API as the API to be used for the task, etc. After selecting the API to be used, the administrator 120 may interact with the task system 110 to select and/or designate various parameters used in implementing the API to accomplish the objective of the task. For example, the task system 110 may utilize a form builder to present the administrator 120 with potential parameters and the options for implementing the parameters. Such parameters may include constant values and/or values for which user input may be sought. For constant values, the administrator 120 may designate values that are used each time the task is executed. Such values may include inputs or designations that help the API accomplish the desired objective, paths via which the API is called (or portions thereof), etc. For values for which user input is sought or that may change with different instances of making the API call when executing the task, the administrator 120 may provide a placeholder value that may be replaced when executing the task. By using the placeholder values, the task may include all data necessary to invoke the API, even with sample data in the placeholder values, even though those values are configured to be replaced upon execution of the task. In these and other embodiments, the parameters may include customized values to facilitate accomplishment of the specific functionality desired of the task. For example, the task may be designed to accomplish a specific functionality built upon the API to be invoked, and the parameters may include values to accomplish the task when the API call is made using the parameters as one or more of the inputs to the API call.

In some embodiments, the placeholder values may include security tokens or other authentication components. For example, the placeholder values may include a user name, a password, an OAuth token, etc. that may be updated/replaced upon execution of the task. In some embodiments, the task system 110 may update the token automatically upon execution of the task without direct user input.

In some embodiments, a task may include elements to generate or otherwise present a user interface to the end-user 130 when executing the task. For example, the user interface elements may be generated to facilitate receiving user input for obtaining values to replace the placeholder values of the parameters. In some embodiments, the user input themselves may be the values used to replace the placeholder values (e.g., the end-user 130 may input how many of their most recent emails they would like retrieved, the end-user 130 may input their password, etc.). Additionally or alternatively, the user input may be used to generate the replacement value by some processing or use of the user input to obtain the replacement value (e.g., the end-user 130 inputs a credential that is used to obtain a token that is used as the replacement value, the end-user 130 selects a sheet from a spreadsheet file). In some embodiments, a given value for a parameter may be a combination of both constant and placeholder values. For example, a mixed constant value and placeholder of (from/emailAddress/address) eq ‘<?>’ where a placeholder value of <?> that is replaceable by user input may be combined during execution of the task as a single parameter used as an input by the API call.

The task system 110 may utilize different types of parameters when generating a task. For example, the task system 110 may utilize header parameters that may be embedded within a header of an API call for the API associated with the task. As another example, the task system 110 may utilize path parameters that may be used as all or a portion of an address or path used to identify a location of an API call or the path of a resource used by the API when executing the API call (e.g., the field user_id in the path /api/v2/{user_id}/post?message=‘xyz’). As another example, the task system 110 may utilize query string parameters that may be used by the API when executing the API call (e.g., the field MSG in the path /api/v2/{user_id}/post?message={MSG}). In some embodiments, the query string parameters may include placeholder values to be replaced by end-user input. As an additional example, the task system 110 may utilize request body parameters that may be configured to add the parameters into the body of the API call.

In some embodiments, for placeholder values, each placeholder may include an identifier of the placeholder, a label for the placeholder (e.g., a label to appear in a web form or other user interface to obtain user input), a set of instructions to be presented to the end-user 130 when obtaining the user input (e.g., a type of input expected, an example of input, etc.), a set of options from which the end-user 130 may make a selection (e.g., a value that may be null for generic inputs, or may include “A”, “B”, and “C” so the user may select between “A”, “B”, and “C” when providing input), a placeholder default value (e.g., the actual default value that is to be replaced when executing the task), and/or a type (e.g., identifying which of a variety of potential categories of placeholder values to which the present placeholder corresponds). In some embodiments, the type of placeholder may include a token (e.g., an OAuth2 token, a username, etc. and may be designated as placeholder.token.oauth), a string (e.g., indicating a string is the expected input from the user and may be designated as placeholder.string), an integer (e.g., indicating an integer is the expected input from the user and may be designated as placeholder.int), a decimal (e.g., indicating a decimal is the expected input from the user and may be designated as placeholder.decimal), a number (e.g., indicating a number is the expected input from the user and may be designated as placeholder.number), an email (e.g., indicating an email is the expected input from the user and may be designated as placeholder. email), a URL (e.g., indicating a URL is the expected input from the user and may be designated as placeholder.url), a list (e.g., indicating a list is shown from which the user may select one item, and may be designated as placeholder.list) where the elements of the list may be obtained from the set of options, a multi-list (e.g., indicating a list is shown from which the user may select multiple items, and may be designated as placeholder.multilist) where the elements of the list may be obtained from the set of options, and/or a Boolean (e.g., indicating that the parameter expects True or False as the input, and may be designated as placeholder,boolean). In some embodiments, multiple values may be combined into a single input for the API call (e.g., a Boolean value and another constant value or placeholder value) and may be represented as a list or string placeholder.

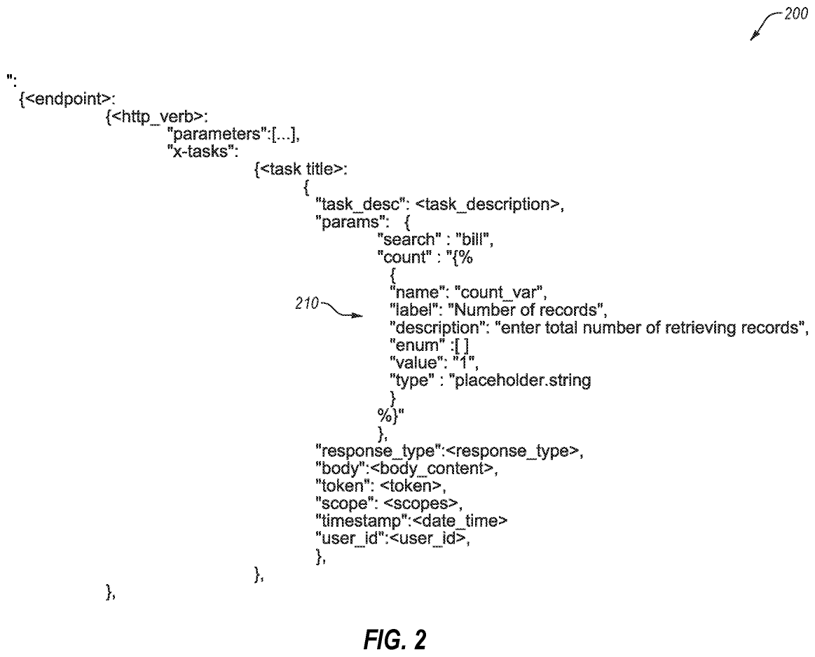

In some embodiments, the task system 110 may utilize a consistent style and/or naming convention when generating tasks such that the tasks may be implemented consistently. One example of a computer-readable implementation of a task object is illustrated in FIG. 2. A given task may include any of a variety of information fields, such as an identifier of the API specification 140 associated with the task, a task title that may be unique for a given endpoint and/or HTTP verb (e.g., the same task title may be used for different tasks associated with different API vendors/HTTP verbs), a task description that provides a descriptive summary of the task, an array of the parameters used by the task (e.g., a dictionary that represents the list of parameters used by the task and their corresponding values, including placeholder values), body content of the API call, one or more tokens used in authentication for using the API and/or for accessing a user account associated with the API, any scopes used to execute the task (e.g., the permissions granted for a given credential for accessing the API), a timestamp of when the current task was generated, an identifier of the administrator 120 who created the task, etc.

In some embodiments, after a task has been generated it may be stored in a task database 112 of the task system 110. The task database 112 may represent a repository of generated tasks that may be accessed by end-users 130 for selecting tasks for execution. Additionally or alternatively, the administrator 120 may use the tasks of the task database 112 as templates or samples when generating new tasks.

### Task Execution

In some embodiments, the task system 110 may facilitate execution of a task by the end-user 130. For example, the end-user 130 may interact with the task system 110 and the task system 110 may present tasks of the task database 112 (e.g., tasks that have been completed) to the end-user 130. In some embodiments, the end-user 130 may perform a text search or other query in searching for a task from the task database 112. For example, the search may be a natural language query (NLQ) search that may search within the task titles, descriptions, API specification 140, API titles, etc. In some embodiments, the task system 110 may suggest tasks based on the capabilities of the task system 110, other searches of the end-user 130, tasks which have been verified, etc. Additionally or alternatively, the end-user 130 may navigate among the tasks by categories such as API host, purpose of the task, age of the task, creator of the task, etc. The end-user 130 may select a task for execution. In some embodiments such a selection may identify the API specification 140 and/or a task identifier associated with the task to retrieve the task from the task database 112.

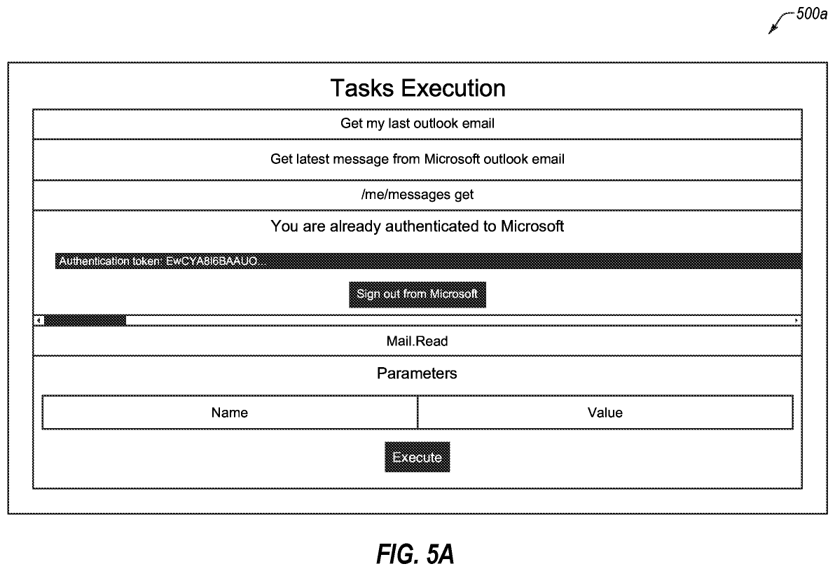

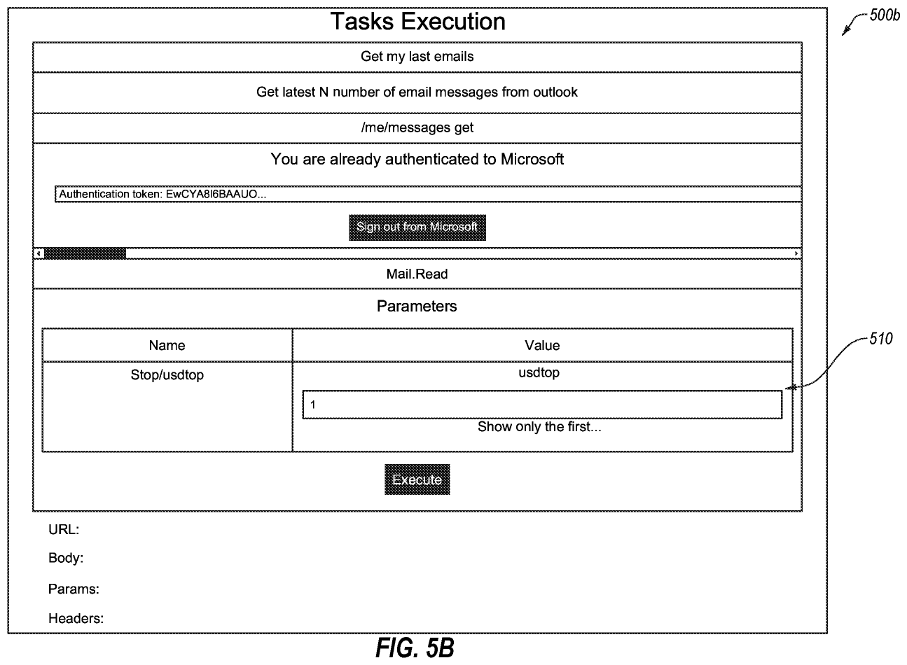

After the end-user 130 has selected a task for execution, the task system 110 may perform operations to obtain all of the information necessary to generate code to execute the task. For example, if there are placeholder values in the task, the task system 110 may generate web forms or other user interfaces via which the end-user 130 may provide user input to generate the values to replace the placeholder values. As another example, the task system 110 may verify an age of a token and may refresh the token if it is expired. Using any collected input and/or tokens, the task system 110 may generate code for implementing an API call to the API associated with the task using the parameters from the task, including any based on user input from the end-user 130. An example of a user interface for task execution without placeholder values seeking user input is illustrated in FIG. 5A, and an example of a user interface for task execution that includes placeholder values where user input is sought is illustrated in FIG. 5B.

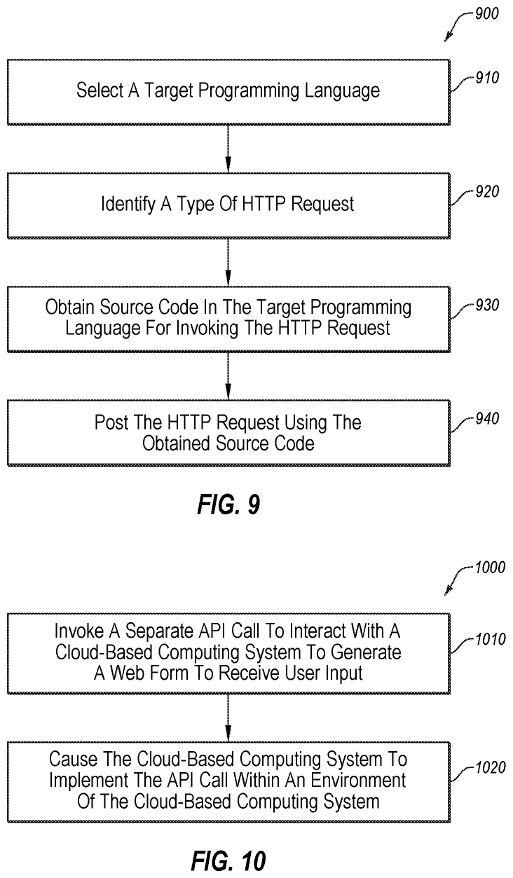

In some embodiments, the end-user 130 may designate a particular programming language in which the end-user 130 desires the API call to be implemented. For example, the end-user 130 may select a language such as PYTHON, JAVA, JAVASCRIPT, etc., and the task system 110 may generate code in the corresponding programming language for implementing the API call according to the target programming language. In some embodiments, the programming language may be selected by the API host 150 such that the target programming language may be used for compliance with the API host 150 and/or an endpoint to which the API call is going to be directed. One example of identifying the programming language may be described with greater detail in FIG. 9.

In some embodiments, the end-user 130 may identify a particular cloud system 160 upon which the end-user 130 would like the task executed and/or in which the API call of the task is to be executed. For example, the end-user 130 may designate a task to be executed completely within a RUNMYPROCESS cloud system, an AMAZON WEB SERVICES (AWS) cloud system, a MICROSOFT cloud system, a GOOGLE cloud system, etc. In some embodiments, the entire task execution, including presenting of a user interface to obtain user input may be implemented via the cloud system 160. For example, the task system 110 may invoke an API of the cloud system 160a to cause the cloud system 160a to generate a user interface for presentation to the end-user 130 to obtain user input. The task system 110 may then generate a complete API call using the user input obtained via the cloud system 160a and the complete API call may be provided to the cloud system 160a for execution of the API call via the cloud system 160a rather than being executed via the task system 110. One example of executing the task in a cloud-based system may be described with greater detail in FIG. 10. While the cloud systems 160 are provided as one example, the end-user 130 may identify a local server (such as the task system 110), a remote serer (such as the API host 150), a local computer (such as a computing device used by the end-user 130 to access the task system 110), etc.

In some embodiments, based on the results indicating a successful execution of the API call based on execution of the task, the task may be annotated within the task database 112 as verified as successful such that the end-user 130, when seeking a task to execute, or the administrator 120, when seeking a task as a template, may be aware of which tasks have been successfully executed. For example, a visual indicator such as a check mark may indicate a verified task. In some embodiments, some or all of the results may be stored in the task database 112.

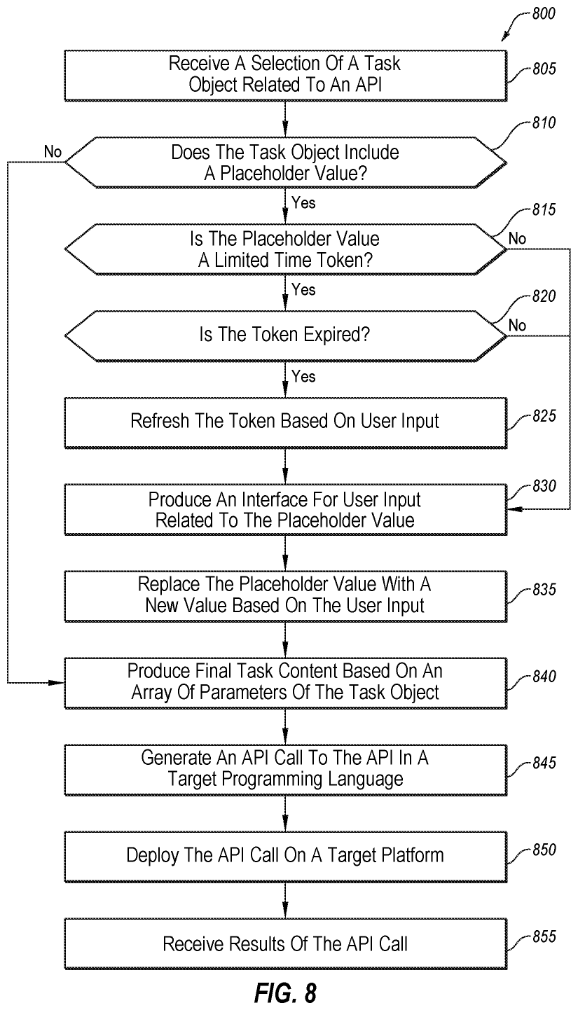

In some embodiments, when executing a task, the task may include credentials that may be used at one or more stages of executing the task. For example, when acquiring user input for placeholder parameters, the parameter may include a username and/or password for authenticating with the API host 150 and/or a third party computing system. In some embodiments, one of the placeholders may include an API token, such as an OAuth and/or an OAuth2 token, or any other format. In some embodiments, the user interface may be configured to provide access to the API host 150 such that the end-user 130 may provide credentials directly to the API host 150 rather than providing credentials to the task system 110 directly. For example, an alternative API call for signing in or authenticating the user may be called or used as part of the acquisition of user input prior to generating the API call code for the task. One example of executing a task may be described with greater detail in FIG. 8.

In some embodiments, the task system 110 may be implemented using a REST API, and/or the REST API may act as a liaison to provide access to the task system 110 for other external and/or internal systems, such as a third-party. For example, accessing tasks, requesting tasks, and selecting tasks may be implemented as API calls such as GET calls to retrieve a list of all/suggested tasks and/or a task for execution. The REST API may interact with the task database 112 to retrieve APIs and/or lists thereof. For example, when a task is requested for execution, the task system 110 may extract the placeholder values and may provide a version of the placeholder information in a first format (such as JSON), which may be rendered in a format viewable by the end-user 130 for providing input (such as HTML pages).

When using the REST API for token authentication, after requesting an API for execution, if the token is expired or has not been acquired yet for the end-user, the authorization URL may be conveyed to the user. The user may interact with the authentication system (e.g., the API host 150) via the site accessed by the authorization URL, and an interfacing system may obtain the callback authorization code and may utilize it to execute the API and/or to refresh the token with the authentication system. Using the authorization code (e.g., OAuth2 token) and/or after refreshing the authorization code, the task system 110 may generate the code and/or execute the API call using the authorization code and provide the response to the end-user 130. Task Combination

In some embodiments, the task system 110 may utilize one or more of the responses of the

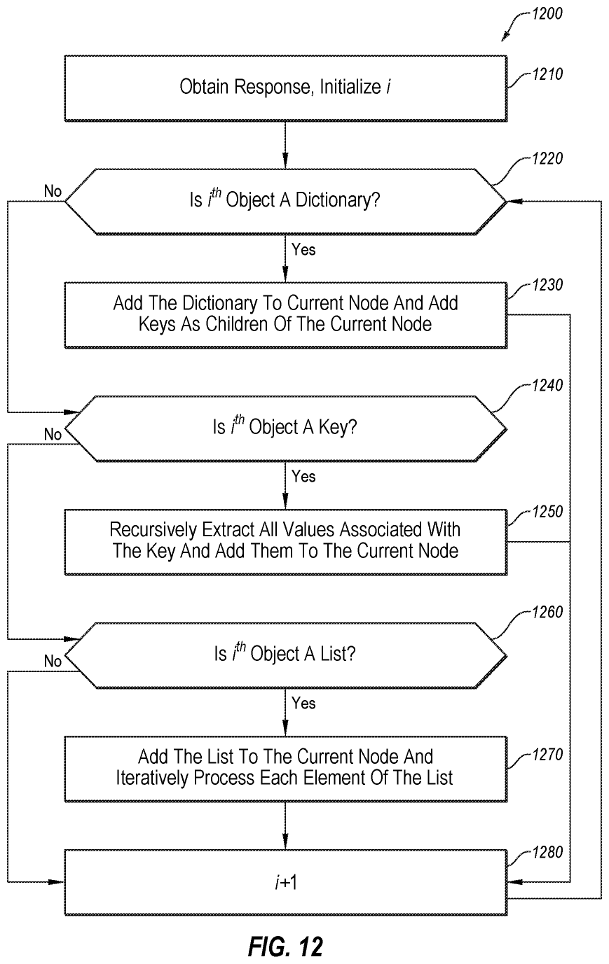

API calls from executed tasks to analyze the tasks so the tasks may be combined into an integrated task. For example, each of the responses from executed tasks may be stored by the task system in the task database 112. The task system 110 may analyze the responses and use the response data to generate a schema for a given response, which may include a data representation of the given response in a consistent format. For example, different responses may take different forms or formats, even for the same API call using different endpoints. An example of taking a given response to executing a task may be illustrated in FIG. 12.

In some embodiments, when analyzing the responses from executing tasks to generate schemas, the task system 110 may consider a subset of responses. For example, the task system 110 may consider successful responses (e.g., a response with a code indicating that the API call was successful). In some embodiments, multiple or even all of the successful response to executing tasks may have associated schemas generated. In these and other embodiments, certain responses may be excluded from analysis to generate schemas, such as an informational response (e.g., providing protocol-level information), a redirection response (e.g., indicating that the client of the API call is to take some action to complete the request, such as when an authorization URL is sent to the client of the API call), a client error response (e.g., indicating that an error occurred for which the client of the API call is responsible), and/or a server error response (e.g., indicating that an error occurred for which the API host 150 is responsible). For certain API hosts 150, the API response to executing the task may include a code with a form of 2XX indicating a successful API call.

In some embodiments, the task system 110 may cluster the schemas representative of the responses of executing the tasks using a machine learning model. For example, the machine learning model may learn to cluster the response schemas based on any of a variety of factors, such as the type of response (e.g., the response includes a string of values, a set of email addresses, a spreadsheet, a URL or path, etc.), the provider of the API, the identifier of the task, the identifier of the API, etc. In some embodiments, the response schemas may be clustered by the machine learning system based on placeholder values of the task (e.g., the task input) to which the response schema was responsive, etc. In these and other embodiments, the clustering may be a single process across some or all of the factors. Additionally or alternatively, there may be separate clusters and/or clusterings based on the outputs of the tasks (e.g., the response schemas) and the inputs to the tasks (e.g., the placeholder values).

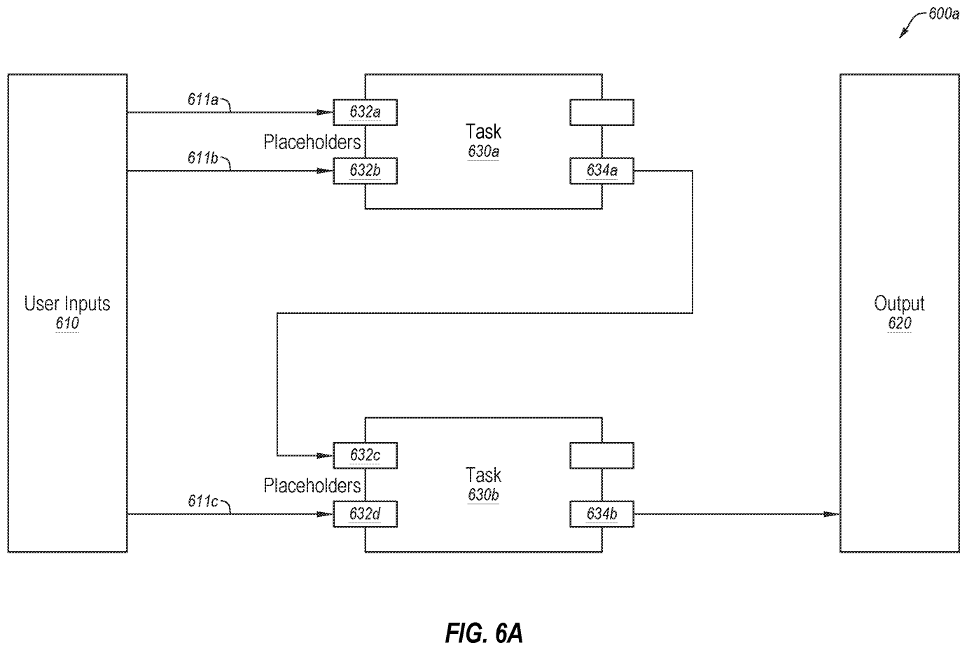

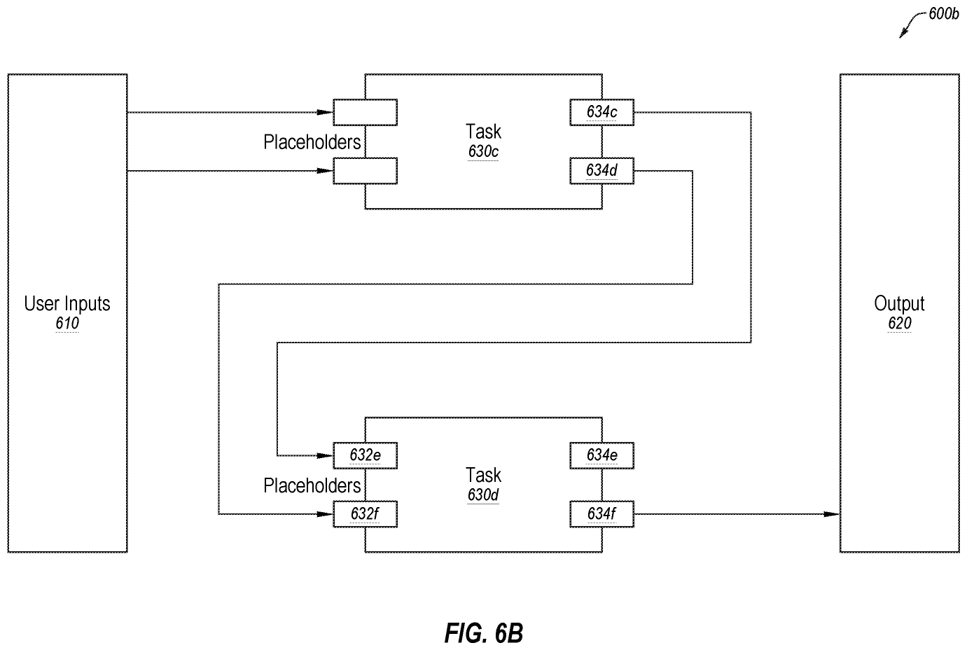

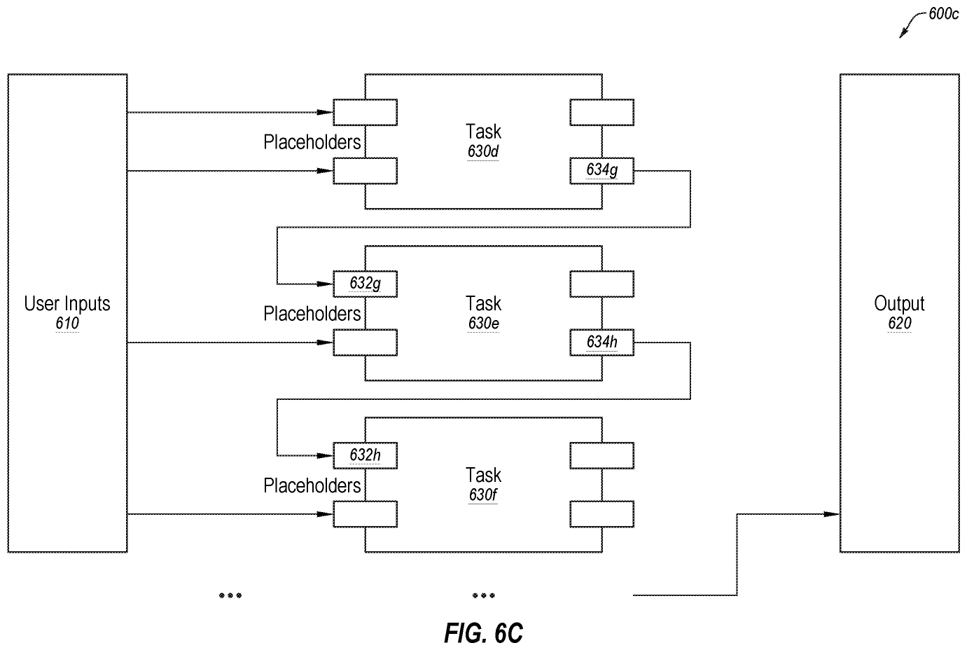

Using the clusters, the task system 110 may create integrated tasks where multiple tasks are combined to perform a single objective. For example, a series of tasks may operate independently or cooperatively to achieve the single objective of the integrated task. In some embodiments, an input of one task (e.g., a placeholder value) may be filled by the output (e.g., the response) of another task in an integrated task including both tasks. Various examples of combinations of such tasks into integrated tasks are illustrated and described with references to FIGS. 6A-6C.

One example of such an integrated task includes an integrated task for creating a worksheet in a cloud-based spreadsheet program. An API endpoint for creating the worksheet may utilize an identifier within a cloud-based system of a cloud drive identifier for the spreadsheet. A separate task may be executable for getting a cloud drive identifier. The tasks may be integrated such that the first task in the integrated task may obtain the cloud drive identifier and the second task may use the obtained cloud drive identifier as an input of where to create the worksheet for the cloud-based spreadsheet program.

As another example, if the end-user 130 desires to use a particular session when accessing an API associated with a cloud-based spreadsheet program, a first task may be used to establish and/or otherwise acquire a session identifier, which may be provided as an input into the second task of performing functions with the cloud-based spreadsheet program.

In some embodiments, the task system 110 may predict or suggest certain task integrations based on the clusters of response schemas. Additionally or alternatively, the administrator 120 may manually map certain placeholder values of a first task to one or more of the responses from executing one or more other tasks to create an integrated task. In some embodiments, the administrator 120 may utilize a GUI of the task system 110 to draw or otherwise string tasks together to generate the integrated tasks.

Modifications, additions, or omissions may be made to the system 100 without departing from the scope of the present disclosure. For example, in some embodiments, the system 100 may include any number of other components that may not be explicitly illustrated or described.

FIG. 2 illustrates an example of a computer-readable representation of a task 200, in accordance with one or more embodiments of the present disclosure. The task 200 illustrates one example of a representation of a task 200, and any such representation may be used. For example, the task 200 may represent a schema or framework within which tasks may be consistently structured. A specific implementation of a task using the schema may be referred to as a task specification.

As illustrated in FIG. 2, the task 200 may include an identification of the endpoint to be used when performing the API call, the HTTP verb used, and the inputs (e.g., API parameters) used to execute the API call. Within a definition portion of the task 200, the task 200 may include a task title, a task description, and the parameters of the task used in the API call and used by the task 200. As illustrated in FIG. 2, the task 200 includes a placeholder 210 that expects a string value as the input. The variable name is count_var and the label presented for the user to enter input is “Number of records” with instructions that state “enter total number of retrieving records”. The placeholder value to be replaced is initially a 1. When the API call is implemented, one or more of the API parameters used in the API call are replaced with the parameters of the task “search”:“bill”, “count”:“{% . . . where the count value may be replaced based on the user input.

As illustrated in FIG. 2, the task 200 may additionally include an expected response type, the body content of the API call, the token(s) used when making the API call, the scope(s) used when making the API call, the timestamp of when the task was created, and/or the administrator who created the task.

Modifications, additions, or omissions may be made to the task 200 without departing from the scope of the present disclosure. For example, in some embodiments, the task 200 may include any number of other components that may not be explicitly illustrated or described. For example, while a single parameter is illustrated that seeks user input, any number of parameters may be identified, and may include constant values, placeholder values, or combinations thereof.

FIG. 3 illustrates an example of a user interface 300 for selecting a category of tasks, in accordance with one or more embodiments of the present disclosure. For example, an administrator may be presented with the user interface 300 to facilitate the selection of an API or sample task to use as a template when generating a task.

The user interface 300 may include one or more windows 310 (such as the windows 310a, 310b, 310c, and 310d) representative of a given API. In some embodiments, the information of the APIs corresponding to the windows 310 may be obtained via the API specification (e.g., an OAS of the API). Using the window 310c as an example, the window 310c may include a title 312c, a version 314c, a description 316c, and a button 318c. By invoking the button 318c, the administrator may be taken to a list of tasks that may be performed using the given API associated with the window 310c. For example, the tasks may include already-generated tasks, a template of a task associated with the API, etc.

Modifications, additions, or omissions may be made to the user interface 300 without departing from the scope of the present disclosure. For example, in some embodiments, the user interface 300 may include any number of other components that may not be explicitly illustrated or described. For example, the window 310 for a respective API may include a logo or other indicator identifying the provider, producer, etc. of the respective API.

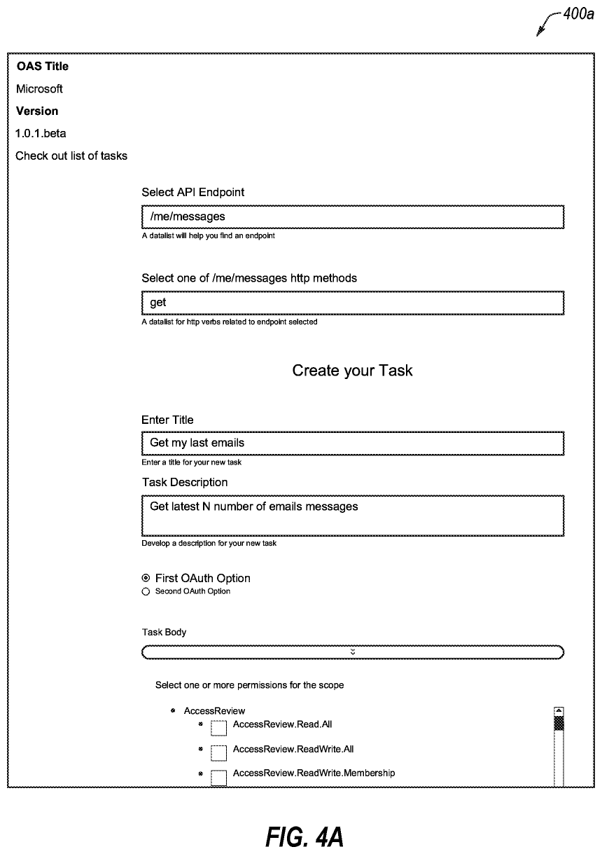

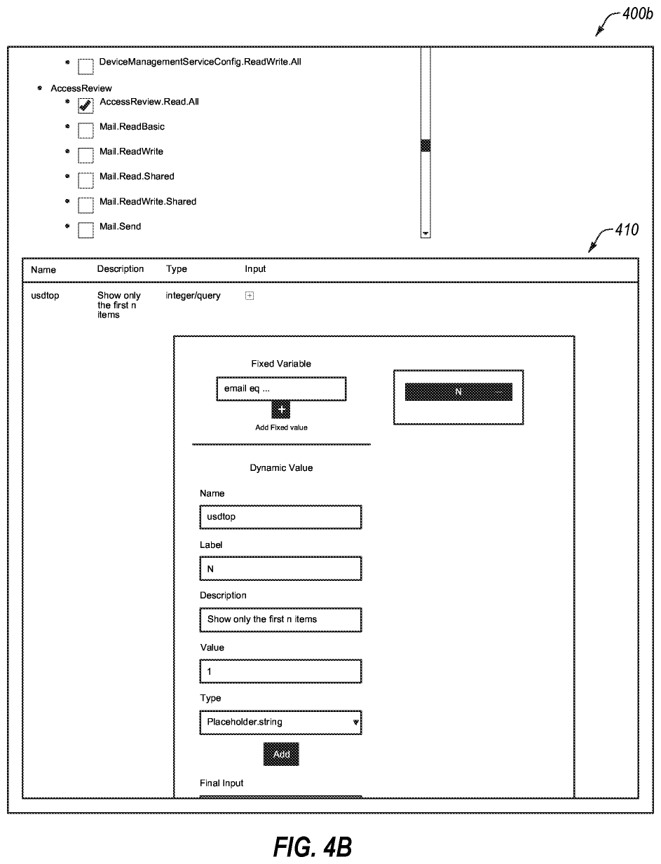

FIGS. 4A and 4B illustrate examples of user interfaces 400a and 400b, respectively, used in task generation, in accordance with one or more embodiments of the present disclosure.

As illustrated in FIG. 4A, upon selecting a task for generation, an administrator may be presented with a series of user interface elements to facilitate generation of the task. For example, the administrator may be prompted to select an endpoint for accessing the API (e.g., from a dropdown menu) and an HTTP verb for performing the API call. The administrator may further be prompted for a title and/or description of the task, a type of authentication, a scope, etc. In some embodiments, certain aspects, such as the type of authentication or scope, may be prepopulated or forced based on the API and/or endpoint selected.

As illustrated in FIG. 4B with the interface 400b, the administrator may be presented with a window 410 via which the administrator may input data regarding constant value parameters and/or placeholder parameters. For example, the administrator may provide a placeholder parameter under the heading “Dynamic Value” and may input the Name, Label, Description, Value, and/or Type of the placeholder value.

As will be appreciated, FIGS. 4A and 4B illustrate examples of interfaces 400a and 400b but any number of or variations in the interfaces may be used to facilitate generation of a task.

Modifications, additions, or omissions may be made to the user interfaces 400a and 400b without departing from the scope of the present disclosure. For example, in some embodiments, the interfaces 400a and 400b may include any number of other components that may not be explicitly illustrated or described.

FIGS. 5A and 5B illustrates examples of user interfaces 500a and 500b used in task execution, in accordance with one or more embodiments of the present disclosure. FIG. 5A illustrates an example in which a task is executed where an authentication token is current and no other input is required from the user. FIG. 5B illustrates an example in which a task is executed where the authentication token is current and input is requested from the user.

As illustrated in FIG. 5A, the task to be executed may have the title “Get my last outlook email” with a description of “Get latest message from Microsoft outlook email.” The task may use the endpoint/me/messages with the HTTP verb GET. The API may use an OAuth2 token to verify the user and/or their account with the API host (e.g., MICROSOFT). However, the authentication token may be stored as associated with the user such that the user may be indicated as already being authenticated with the API host. As illustrated, no further parameters are sought such that the task may be ready to execute without further input.

As illustrated in FIG. 5B, the task to be executed may have the title “Get my last emails” with a description of “Get latest N number of email messages from outlook.” The same endpoint, verb, and authentication token are used as for the task illustrated in FIG. 5A. The interface 500b includes the field 510 via which the user is prompted to input a value for N. For example, the user may be able to input an integer in the field 510 identifying how many emails to retrieve when executing the task. In some embodiments, after inputting a value, the user may be presented with a confirming message via the user interface 500b that the input was successful, properly formed, etc.

Modifications, additions, or omissions may be made to the user interfaces 500a and 500b without departing from the scope of the present disclosure. For example, in some embodiments, the interfaces 500a and 500b may include any number of other components that may not be explicitly illustrated or described.

FIGS. 6A, 6B, and 6C illustrate example visual representations of example combinations of tasks into integrated tasks 600a, 600b, and 600c, respectively, in accordance with one or more embodiments of the present disclosure. As illustrated in FIGS. 6A, 6B, and 6C, user inputs 610 may be provided by an end-user when executing one or more tasks 630. The tasks may include placeholder values 632 and outputs 634 of the tasks 630 being executed. After completion of the integrated tasks 600, an output 620 may be achieved. The examples of integrated tasks 600a, 600b, and 600c are merely illustrative. Any combination and/or order of task combinations may be utilized to derive integrated tasks in accordance with the present disclosure.

As illustrated in FIG. 6A, when executing the task 630a, user input 611a may be obtained to generate a replacement value for the placeholder 632a and user input 611b may be obtained to generate a replacement value for the placeholder 632b. Using the replacement values, the task 630a may be used to generate the associated API call and obtain the response 634a. The response 634a may then be used as a replacement value for the placeholder 632c of the task 630b rather than seeking additional user input. When executing the task 630b, the task 630b may obtain the user input 611c to facilitate replacement of the placeholder 632d with a replacement value based on the input 611c. Execution of the task 630b may result in the generation of the corresponding API call that uses the response 634a and the user input 611c-based replacement values. The corresponding API call may yield the output 634b which may be provided as the output 620 to the integrated task 600.

As can be seen from FIG. 6A, by stringing together two tasks, a hybrid of user input 611c and responses 634a of other tasks maybe used when generating an API call by executing the task 630b.

As illustrated in FIG. 6B, rather than the second task in an integrated task (task 630d) using both user input and the output of an earlier task (task 630c) to generate replacement values for the placeholders 632e and 632f of the second task 630d, the second task 630d may use the outputs 634 of one or more earlier tasks, such as the outputs 634c and 634d of the task 630c. While illustrated as both coming from the task 630c, it will be appreciated that any number of earlier tasks may contribute one or more of the outputs of the earlier tasks to a later task when generating the replacement values for task execution.

Using the outputs 634c and 634d of the task 630c, the task 630d may generate outputs 634e and 634f which may facilitate the output 620.

As illustrated in FIG. 6C, in some embodiments, a string of tasks 630d, 630c and 630f may be used when generating the integrated task 600c. For example, the first task 630d may generate an output 634g based on the API call of the task 630d. The output 634g may be used to generate the replacement values for the placeholder 632g, while another placeholder of the task 630e may have a replacement ask generated based on user input. The API call may be generated for the task 630e based on the replacement values yielding the output 634h. The output 634h may be used to generate a replacement value for the placeholder 632h of the task 630f. The task 630f may be executed using user input and the output of the task 630e to generate the replacement values when creating the API call corresponding to the task 630f. Any number of such tasks (which may or may not use user input and the outputs of one or more earlier tasks) may yield the ultimate output 620 of the integrated task 600c.

Modifications, additions, or omissions may be made to the integrated tasks 600a, 600b, and/or 600c without departing from the scope of the present disclosure. For example, in some embodiments, the integrated tasks 600a, 600b, and/or 600c may include any number of other components that may not be explicitly illustrated or described. For example, any number of tasks with any number of placeholders and/or outputs mapped in any configuration are considered as within the present disclosure.

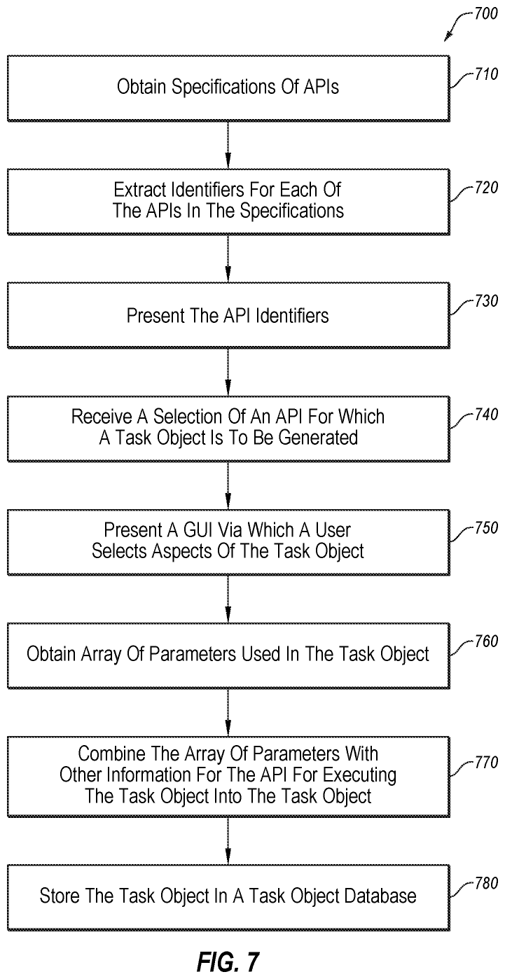

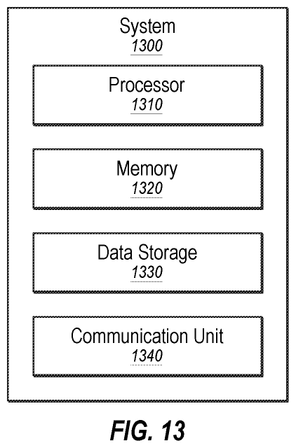

FIGS. 7-12 illustrate various flowcharts of various example methods in accordance with the present disclosure. One or more operations of the various methods illustrated in FIGS. 7-12 may be performed by a system or device, or combinations thereof, such as the task system 110 of FIG. 1, and/or the computing system 1300 of FIG. 13. Although illustrated as discrete blocks, various blocks of the methods illustrated in FIGS. 7-12 may be divided into additional blocks, combined into fewer blocks, or eliminated, depending on the desired implementation.

FIG. 7 illustrates an example flowchart of an example method 700 of task generation, in accordance with one or more embodiments of the present disclosure.

At block 710, one or more specifications of APIs may be obtained. For example, a task system (such as the task system 110 of FIG. 1) may access one or more API specifications (such as the API specifications 140 of FIG. 1). In some embodiments, the API specifications may be in an OAS format and/or may be hosted by an API host (such as the API host 150 of FIG. 1).

At block 720, identifiers for each of the APIs may be extracted from the specification. For example, a title, URL, description, version, etc. may be extracted from the API. In these and other embodiments, additional information may also be extracted from the specification, such as endpoints, authorization type, header and/or body content associated with calling the API, etc.

At block 730, the API identifiers may be presented. For example, an administrator (such as the administrator 120 of FIG. 1) may be presented with a list of APIs that are available to form the basis of a task to be generated when interacting with a task system (such as the task system 110 of FIG. 1). One example of such a presentation is illustrated in FIG. 3.

At block 740, a selection of an API for which a task object is to be generated may be received. For example, the administrator may select a particular API, a template of a task, a preexisting task, etc. In these and other embodiments, the administrator may elect to edit, copy, etc. an existing task when selecting the API for generating the task.

At block 750, a graphical user interface (GUI) may be presented via which a user selects aspects of the task object. For example, the administrator may be presented with one or more elements of a GUI via which the administrator may input information regarding the task, such as a title, description, and one or more parameters or values associated with the task.

At block 760, an array of parameters used in the task object may be obtained. For example, the administrator may utilize the GUI of the block 750 to identify one or more placeholder values and/or one or more constant values as parameters in the task.

At block 770, the array of parameters may be combined with other information and/or inputs for the API into the task object for executing the task object. Such information may include, for example, any of the information extracted at the block 720. In some embodiments, upon the completion of the block 770, the task object may include all of the programming code and/or information such that the API call may be executed to achieve the desired objective of the task.

FIG. 8 illustrates an example flowchart of an example method 800 of task execution, in accordance with one or more embodiments of the present disclosure.

At block 805, a selection of a task object may be received. For example, an end-user (such as the end-user 130 of FIG. 1) may interact with a task system (such as the task system 110 of FIG. 1) to select a task to be executed. The task object may be related to a particular API as described in an API specification (such as the API specification 140 of FIG. 1). In these and other embodiments, the task selection may identify an API specification and a task, which may permit the same task name across different APIs (e.g., the task title “Get last email” may be used across multiple email provider APIs).

At block 810, a determination may be made whether the task object includes a placeholder value. For example, the task system may parse the syntax of the computer-readable task object to view the parameters of the task object to determine if the task includes placeholder values. If the task object does include placeholder values, the method 800 may proceed to the block 815. If the task object does not include placeholder values, the method 800 may proceed directly to the block 840.

At block 815, a determination may be made whether the placeholder value is a limited time token. For example, the task system may verify whether any of the placeholder values are OAuth2 tokens or any other time-limited authorization credentials/tokens. If any of the placeholder tokens include limited time tokens, the method 800 may proceed to the block 820. If none of the placeholder tokens include limited time tokens, the method 800 may proceed to the block 830. In some embodiments, a security token or other authenticating credential may be included as a parameter but may not be one that is renewed.

At block 820, a determination may be made whether the token is expired. For example, the task system may observe meta-data of the token and may compare it to a security policy. As another example, the token may be provided to the authenticating system to verify the token. If the token is expired, the method 800 may proceed to the block 825. If the token is not expired, the method 800 may proceed to the block 830.

At block 825, the token may be refreshed based on user input. For example, when authenticating the token, the URL for signing in may be returned by the authenticating system and the associated page may be presented to the end-user for authenticating themselves to refresh the token. As another example, the end-user may be prompted for a username/password, a PIN, a locally stored security certificate, or any other security credential. In some embodiments, the token may be refreshed automatically by the task system without user input.

At block 830, an interface for receiving user input related to the placeholder value may be produced. For example, a web form may be generated by the task system to prompt the end-user for input. As another example, an API of a cloud-based system may be invoked to cause the cloud-based system to create an interface to prompt the end-user for input. As a further example, a separate page may be opened within a frame (such as an iFrame) via which the end-user is prompted to provide credentials.

At block 835, the placeholder value may be replaced with a new value based on the user input. For example, the task system may directly replace the placeholder value with the user input in an array of parameters of the task object. As another example, the task system may perform some processing or other manipulation or formatting based on the user input to arrive at a value to replace the placeholder value. For example, if the user input is a click selecting one or more items in the list, the selections may be formatted into a syntax usable by the API call.

At block 840, final task content may be produced based on an array of parameters of the task object. For example, the task system may compile the array of parameters, including any newly generated values replacing placeholder values, a header of the API call, a body of the API call, an endpoint of the call, the HTTP verb of the API call, a URL query, a URL path, etc.

At block 845, an API call to the API may be generated in a target programming language. For example, the end-user may identify a specific programming language in which they would like the API call to be implemented. As another example, a given end point selected by the end-user (or by an administrator when generating the task) may utilize a particular programming language and the target programming language may correspond to the particular programming language. In some embodiments, a type of HTTP request for the API call may be identified and/or designated by the task. In these and other embodiments, based on the target programming language and/or the type of HTTP request, programming code to implement the API call utilizing the parameters of the task object may be generated. For example, if the HTTP verb is “GET,” the API call of GET request may be generated in the target programming language subject to the parameters of the task. In some embodiments, the programming code may be implemented in segments based on the objective of each segment of the final task content, such as the API body, header, URL query, etc.

At block 850, the API call may be deployed on a target platform. For example, the task system may deploy the API call locally and/or on a cloud-based system. In some embodiments, the local system may use any operating system or structure, such as a mobile device using an ANDROID® or iOS® operating system, a computing device using a WINDOWS® or MacOS® operating system, a web browser, etc.

When deploying the API call locally, the task system may generate the programming code as described above and execute the code locally.

When deploying the API call on a cloud-based system, the task system may utilize a web generator API call via which the task system may invoke the cloud-based system to perform certain functions. A script may be used to replace content with HTML code and/or otherwise generate HTML code that may be executed by the cloud-based system to interface with the user and/or the administrator in generating and/or selecting inputs when executing a task to prepare the API call based on the task. In some embodiments, the cloud-based system may interface with another secure cloud-based system to execute the API call.

In some embodiments, the cloud-based system may obtain and/or store a token of a user such that the token may be used and/or reused when executing tasks. For example, when the cloud-based system attempts to authenticate a user, if it is a new user or the token of the user has expired, an authorization URL may be returned by the authenticating system. The cloud-based system may convey the page of the authorization URL to the end-user, and may listen to callback information after the user submits credentials to authenticate. The cloud-based system may additionally or alternatively monitor responses from the API call and/or the authentication process to store the results and/or to store the updated token of the end-user.

In some embodiments, the cloud-based system may provide and/or maintain a database of tasks such that the end-user may interface with the cloud-based system to request, identify, and/or execute tasks rather than interacting with the task system.

At block 855, results of the API call may be received. For example, a frame or browser window may be opened within which the results may be displayed. As another example, the user interface with the task system may directly display the results. In some embodiments, no result may be displayed (e.g., if the task sends an email, there may be no response to be displayed). In these and other embodiments, a confirmation may be displayed that the task has been successfully executed. In some embodiments, the results of the API call may be stored or otherwise processed.

FIG. 9 illustrates an example flowchart of another example method 900 of task execution, in accordance with one or more embodiments of the present disclosure. The method 900 may be an example implementation of the blocks 845 and/or 850 of FIG. 8.

At block 910, a target programming language may be selected. For example, an end-user (such as the end-user 130 of FIG. 1) may identify a particular programming language in which the API call is to be executed. As another example, an administrator (such as the administrator 120 of FIG. 1) may select a programming language when generating the task under which the task may be executed. In some embodiments, the programming language may be selected based on the capabilities of the endpoint to which the API call may be directed.

At block 920, a type of HTTP request (e.g., HTTP verb) may be identified. For example, the API call may utilize a GET request, a PUT request, a PATCH request, etc. In some embodiments, the type of HTTP request may be set by the administrator and/or may be based on the configuration of the endpoint. As another example, the type of HTTP request may be determined based on the objective of the task.

At block 930, source code in the target programming language may be obtained for invoking the HTTP request. For example, if the target programming language is PYTHON and the type of HTTP request is GET, the corresponding code for implementing a GET request using PYTHON may be obtained. Additionally or alternatively, the remainder of the inputs (e.g., API parameters), body, headers, etc. associated with the API call based on the task may be encoded in conjunction with the code in the target programming language such that after the completion of the block 930, a complete API call may be generated that is configured to accomplish the objective of the task.

At block 940, the HTTP request may be posted using the obtained source code. For example, the complete API call may be posted to implement the HTTP request using the target programming language.

FIG. 10 illustrates an example flowchart of a further example method 1000 of task execution, in accordance with one or more embodiments of the present disclosure. The method 1000 may be an example implementation of the blocks 845 and/or 850 of FIG. 8.

At block 1010, a separate API call may be invoked to interact with a cloud-based computing system to generate a web form to receive user input. For example, if the entire task execution is to be performed via a cloud-based computing system (such as the cloud-based system 160 of FIG. 1), a task system (such as the task system 110 of FIG. 1) may invoke an API call to the cloud-based computing system to cause it to generate an interface via which an end-user (such as the end-user 130 of FIG. 1) may provide user input (such as replacement values for placeholder values for a task, credentials, etc.).

At block 1020, the cloud computing system may be caused to implement an API call associated with a task within an environment of the cloud-based computing system. For example, after collecting user input for the placeholder values of a task, replacing the placeholder values based on the user input, and collecting any other information for generating a complete API call, the task system may provide the computer programming code to implement the API call to the cloud-based computing system with instructions to implement the API call within the environment of the cloud-based computing system.

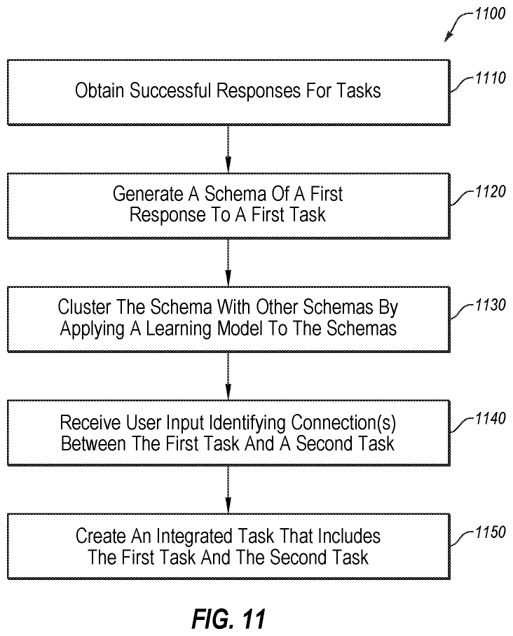

FIG. 11 illustrates an example flowchart of an example method 1100 of task combination, in accordance with one or more embodiments of the present disclosure.

At block 1110, one or more successful response for tasks may be obtained. For example, when executing a task, the task may generate an API call using one or more constant values and/or placeholder values. The response to the API call may be stored in a task database for analysis or other considerations.

At block 1120, a schema of a first response to a first task may be generated. For example, the data of the first response to the API call corresponding to the first task may be analyzed, parsed, etc. to generate a schema of the first response which may represent a data representation of the API response in a consistent format. One example of generating a schema may be described in greater detail in FIG. 1.

At block 1130, the schema may be clustered with other schemas by applying a learning model to the schemas. For example, the learning model may cluster the schemas based on the response type, name of the API, etc. Additionally or alternatively, the learning model may cluster the schemas based on the placeholder values. By clustering the schemas in this manner, a task system may predict or suggest certain connections between one or more tasks such that the response from executing one task may be used in generating replacement values for a placeholder in another task. For example, the task system may identify the type of input or value used by the later task to generate the replacement value and may suggest tasks where the response to executing the task is that type of input or value.

At block 1140, user input may be received that identifies one or more connection(s) between the first task and a second task. For example, an administrator may confirm a suggested connection between two tasks. As another example, the administrator may manually map the connection(s) between the tasks.

At block 1150, an integrated task may be created that includes the first task and the second task. For example, based on the user input received at the block 1140, the task system may generate corresponding programming code that may implement the connection between the first task and the second task such that when the integrated task is executed, the connection is implemented. For example, if the connection is that the response of executing the second task is used to generate the replacement for one of the placeholder values of the first task, the integrated task may include programming such that rather than seeking user input for the replacement value, the response of executing the second task may be used for generating the replacement value.

FIG. 12 illustrates an example flowchart of an example method 1200 of generating a schema based on a response of a successful task execution, in accordance with one or more embodiments of the present disclosure.

At block 1210, a response may be obtained and a variable i may be initialized. For example, a given task may be executed to produce and send an API call. The response from the API call may be stored. Additionally or alternatively, such a response may be recalled from a database. In these and other embodiments, the response may include one or more data objects. In some embodiments, an empty schema of the response may be initialized to which the data objects of the response may be added.

At block 1220, a determination may be made as to whether the i^{th} object in the response is a dictionary. If the i^{th} object is a dictionary, the method 1200 may proceed to the block 1230. If the i^{th} object is not a dictionary, the method 1200 may proceed to the block 1240.

At block 1230, the dictionary may be added to the current node of the schema and keys in the dictionary may be added as children nodes in the schema. For example, if a dictionary includes a series of key-value pairs (or key-multiple value objects), each of the keys may be extracted and added as children nodes in the schema beneath the dictionary node.

At block 1240, a determination may be made as to whether the i^{th} object in the response is a key. If the i^{th} object is a key, the method 1200 may proceed to the block 1250. If the i^{th} object is not a dictionary, the method 1200 may proceed to the block 1260.

At block 1250, the values associated with the key may be recursively extracted until all values are extracted and may be added to the current node. For example, if the data object of the response being analyzed is a key, the key may include multiple values associated therewith. Each of those values may be extracted and associated with the current node that is associated with the key (which may or may not be a child node beneath a dictionary node).

At block 1260, a determination may be made as to whether the i^{th} object in the response is a list. If the i^{th} object is a list, the method 1200 may proceed to the block 1270. If the i^{th} object is not a dictionary, the method 1200 may proceed to the block 1280.

At block 1270, the list may be added to the current node and each element of the list may be iteratively processed. For example, each element of the list may be treated as another object of data within the response such that as i is incremented, the objects of the list may be data objects that are analyzed for inclusion within the schema.

At block 1280, the variable i may be incremented such that the next data object within the schema may be analyzed for inclusion in the schema. In some embodiments, at the block 1280, if the data object is a string there may be no change to the data structure and it may be added to the schema as a string. Additionally or alternatively, for strings a format error may be returned that may cause the string to be skipped or to be presented to an administrator to include the string in the schema in an appropriate manner. At block 1280, if all objects of the response have been analyzed and/or added to the schema, the method 1200 may end rather than incrementing i.

FIG. 13 illustrates an example computing system 1300 to facilitate the generation of, execution of, and/or combination of tasks, according to at least one embodiment described in the present disclosure. The computing system 1300 may include a processor 1310, a memory 1320, a data storage 1330, and/or a communication unit 1340, which all may be communicatively coupled. Any of the operations of the methods 700-1200 of FIGS. 7-12 may be performed by a computing system consistent with the computing system 1300. For example, the computing system 1300 may generate and store a task, execute a selected task, and/or combine multiple tasks into an integrated task.

Generally, the processor 1310 may include any suitable special-purpose or general-purpose computer, computing entity, or processing device including various computer hardware or software modules and may be configured to execute instructions stored on any applicable computer-readable storage media. For example, the processor 1310 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 13, it is understood that the processor 1310 may include any number of processors distributed across any number of network or physical locations that are configured to perform individually or collectively any number of operations described in the present disclosure. In some embodiments, the processor 1310 may interpret and/or execute program instructions and/or process data stored in the memory 1320, the data storage 1330, or the memory 1320 and the data storage 1330. In some embodiments, the processor 1310 may fetch program instructions from the data storage 1330 and load the program instructions into the memory 1320.

After the program instructions are loaded into the memory 1320, the processor 1310 may execute the program instructions, such as instructions to perform any of the methods 200-1100 of FIGS. 2-11, respectively. For example, the processor 1310 may obtain instructions regarding generating and/or storing a task, executing a selected task, and/or combining multiple tasks into an integrated task.

The memory 1320 and the data storage 1330 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 1310. In some embodiments, the computing system 1300 may or may not include either of the memory 1320 and the data storage 1330.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1310 to perform a certain operation or group of operations.

The communication unit 1340 may include any component, device, system, or combination thereof that is configured to transmit or receive information over a network. In some embodiments, the communication unit 1340 may communicate with other devices at other locations, the same location, or even other components within the same system. For example, the communication unit 1340 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 1340 may permit data to be exchanged with a network and/or any other devices or systems described in the present disclosure. For example, the communication unit 1340 may allow the system 1300 to communicate with other systems, such as computing devices and/or other networks.

One skilled in the art, after reviewing this disclosure, may recognize that modifications, additions, or omissions may be made to the system 1300 without departing from the scope of the present disclosure. For example, the system 1300 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method comprising:
receiving a selection of an application programming interface (API) for which a task object is to be generated;
obtaining an array of parameters used in the task object, each element in the array of parameters comprising one or more of a constant value, a placeholder value, or combinations thereof, the placeholder value including programming to elicit user input to replace the placeholder value during execution of the task object;
combining the array of parameters with other information for the API for executing the task object into the task object; and
storing the task object in a task object database.

2. The method of claim 1, further comprising:
obtaining a plurality of specifications of a respective plurality of APIs;
extracting an identifier of each of the plurality of APIs from each of the respective specifications; and
presenting the identifiers of the plurality of APIs in a manner by which a user may make the selection of the API for which the task object is to be generated.

3. The method of claim 1, wherein the array of parameters includes:
a first element that is the constant value; and
a second element that is the placeholder value.

4. The method of claim 1, wherein the task object includes programming to combine the constant value and the elicited user input into a single input for the selected API.

5. The method of claim 1, wherein a given element of the array of parameters is customized based on a target functionality to be implemented on top of the API, the given element selected from the group consisting of:
a header parameter to be included in a header of an API call request to the API;
a path parameter to be included as part of an identifying address in the API call request to the API;
a query parameter to be included as part of a query string in the API call request to the API; and
a body parameter to be included as part of a body of the API call request to the API.

6. The method of claim 1, wherein the placeholder value is selected from the group consisting of:
a token placeholder value to be replaced by user authorization credentials when the task object is executed;
a placeholder string value to be replaced by a user-input string value when the task object is executed;
a placeholder decimal value to be replaced by a user-input decimal value when the task object is executed;
a placeholder integer value to be replaced by a user-input integer value when the task object is executed;
a placeholder number value to be replaced by the user-input integer value or the user-input decimal value when the task object is executed;
a placeholder email address to be replaced by a user-input email address when the task object is executed;
a placeholder uniform resource locator (URL) to be replaced by a user-input URL when the task object is executed;
a placeholder list to be presented for selection of a single item of the placeholder list as the user input when the task object is executed;
a placeholder multi-list to be presented for selection of multiple items of the placeholder multi-list as the user input when the task object is executed; and
a placeholder Boolean value to be replaced by a user-input Boolean value when the task object is executed, the user-input Boolean value determined when the task object is executed based on the received user input.

7. The method of claim 6, wherein the task object includes programming to generate a graphical user interface with which the user interacts to provide the user input.

8. The method of claim 1, further comprising presenting a graphical user interface with which an administrator interacts to graphically or textually select elements of the array of parameters.

9. The method of claim 1, wherein the task object further comprises at least one of:
an API specification identifier identifying an API specification associated with the API of the task;
a task title identifying the task object, the task title unique among task objects using a same hypertext transfer protocol (HTTP) verb and originating at a same endpoint; and
a task description describing the task object;

10. A system comprising:
one or more processors; and
one or more non-transitory computer-readable media containing instructions which, when executed by the one or more processors, cause the system to perform operations, the operations comprising:
receiving a selection of an application programming interface (API) for which a task object is to be generated;
obtaining an array of parameters used in the task, each element in the array of parameters comprising one or more of a constant value, a placeholder value, the placeholder value including programming to elicit user input to replace the placeholder value during execution of the task object;
combining the array of parameters with other information for the API for executing the task object; and
storing the task object in a task object database.

11. The system of claim 10, wherein the operations further comprise:
obtaining a plurality of specifications of a respective plurality of APIs;
extracting an identifier of each of the plurality of APIs from each of the respective specifications; and
presenting the identifiers of the plurality of APIs in a manner by which a user may make the selection of the API for which the task object is to be generated.

12. The system of claim 10, wherein the array of parameters includes:
a first element that is the constant value; and
a second element that is the placeholder value.

13. The system of claim 10, wherein the task object includes programming to combine the constant value and the elicited user input into a single input for the selected API.

14. The system of claim 10, wherein a given element of the array of parameters is customized based on a target functionality to be implemented on top of the API, the given element selected from the group consisting of:
a header parameter to be included in a header of an API call request to the API;
a path parameter to be included as part of an identifying address in the API call request to the API;
a query parameter to be included as part of a query string in the API call request to the API; and
a body parameter to be included as part of a body of the API call request to the API.

15. The system of claim 10, wherein the placeholder value is selected from the group consisting of:
a token placeholder value to be replaced by user authorization credentials when the task object is executed;
a placeholder string value to be replaced by a user-input string value when the task object is executed;
a placeholder decimal value to be replaced by a user-input decimal value when the task object is executed;
a placeholder integer value to be replaced by a user-input integer value when the task object is executed;
a placeholder number value to be replaced by the user-input integer value or the user-input decimal value when the task object is executed;
a placeholder email address to be replaced by a user-input email address when the task object is executed;
a placeholder uniform resource locator (URL) to be replaced by a user-input URL when the task object is executed;
a placeholder list to be presented for selection of a single item of the placeholder list as the user input when the task object is executed;
a placeholder multi-list to be presented for selection of multiple items of the placeholder multi-list as the user input when the task object is executed; and
a placeholder Boolean value to be replaced by a user-input Boolean value when the task object is executed, the user-input Boolean value determined when the task object is executed based on the received user input.

16. The system of claim 15, wherein the task object includes programming to generate a graphical user interface with which the user interacts to provide the user input.

17. The system of claim 10, wherein the operations further comprise presenting a graphical user interface with which an administrator interacts to graphically or textually select elements of the array of parameters.

18. The system of claim 10, wherein the task object further comprises at least one of:
an API specification identifier identifying an API specification associated with the API of the task;
a task title identifying the task object, the task title unique among task objects using a same hypertext transfer protocol (HTTP) verb and originating at a same endpoint; and
a task description describing the task object.

19. One or more non-transitory computer-readable media containing instructions which, when executed by one or more processors, cause a system to perform operations, the operations comprising:
receiving a selection of an application programming interface (API) for which a task object is to be generated;
obtaining an array of parameters used in the task, each element in the array of parameters comprising one or more of a constant value, a placeholder value, the placeholder value including programming to elicit user input to replace the placeholder value during execution of the task object;
combining the array of parameters with other information for the API for executing the task object; and
storing the task object in a task object database.

20. The non-transitory computer-readable media of claim 19,
wherein the array of parameters includes:
a first element that is the constant value; and
a second element that is the placeholder value, and
wherein the task object includes programming to combine the constant value and the elicited user input into a single input for the selected API.
